(19) United States
(12) Patent Application Publication
(10) Pub. No.: US 2025/0278581 A1
(43) Pub. Date: Sep. 4, 2025

(54) METHOD, DEVICE, SYSTEM, AND COMPUTER PROGRAM FOR LOCAL RULE-BASED TRANSLATION AUTOMATION

(71) Applicant: SAMSUNG SDS CO., LTD., Seoul (KR)

(72) Inventors: Sungduck KIM, Seoul (KR); Heesuk LEE, Seoul (KR); Taejin PARK, Seoul (KR); Yeon Sug SHIM, Seoul (KR); Chang Duck KIM, Seoul (KR); Young In YOON, Seoul (KR)

(73) Assignee: SAMSUNG SDS CO., LTD., Seoul (KR)

(21) Appl. No.: 19/064,117

(22) Filed: Feb. 26, 2025

(30) Foreign Application Priority Data
Feb. 29, 2024 (KR) 10-2024-0030078
May 28, 2024 (KR) 10-2024-0069014
Oct. 15, 2024 (KR) 10-2024-0140300

(51) Int. Cl. G06F 40/55; G06F 40/51

(52) U.S. Cl. CPC G06F 40/55; G06F 40/51

(57) ABSTRACT

A processor-implemented method including selecting, based on a given priority table, at least one unique expression set to be applied to a translation of original text from a local rule, the local rule including multiple types of unique expression sets, translating the original text by applying the at least one selected unique expression set to produce translated text, and updating the priority table, based on the produced translated text.

### CROSS-REFERENCE TO RELATED APPLICATION(S)

This application is based on and claims priority under 35 U.S.C. 119 to Korean Patent Applications No. 10-2024-0030078, filed on Feb. 29, 2024, No. 10-2024-0069014, filed on May 28, 2024 and No. 10-2024-0140300, filed on Oct. 15, 2024, in the Korean Intellectual Property Office, the disclosure of which is herein incorporated by reference in its entirety.

### BACKGROUND OF THE INVENTION

### 1. Field of the Invention

The present disclosure relates to a method, a device, a system, and a computer program for local rule-based translation automation and, more particularly, to a method, a device, a system, and a computer program for local rule-based translation automation, wherein translation optimized for a specific field can be provided based on a local rule corresponding to the specific field.

### 2. Description of the Prior Art

In recent years, translation technology and services that translate a given sentence into another language and provide the translated sentence have been continuously evolving with the development of information and communication technology. Furthermore, the quality of translated text has been also rapidly improving with the recent development of artificial intelligence models such as large language models (LLMs).

In this regard, attempts are also being made to provide optimized translations for unique expressions used in specific fields or by specific companies or organizations.

In a more specific example, when there is a local rule based on unique terms or expressions used by a company that develops or provides software or services, it is important to produce the accurate translated text of an official manual or a web page regarding such software or services by reflecting the company's local rule. However, it is still considerably difficult to accurately produce translation optimized for each specific field by reflecting local rules of various fields.

As a result, until recently, the optimal translation that reflects the local rule of a specific field has been assigned to and manually carried out by an expert or the like. This process entails significant time and cost.

In addition, even when translation is performed based on an artificial intelligence model, the translation is processed in a way that predicts the next word based on probability using the parameters inside the artificial intelligence model. Therefore, even with prompt engineering, it may still be difficult to produce an accurate translation optimized for a specific field.

Furthermore, companies that have overseas subsidiaries or provide services to overseas customers may require translation and multilingual support for words or terms used in services, or for sentences or phrases in technical documents or manuals. However, when translation experts are utilized for this purpose, considerable time and cost may be required for workforce procurement and translate work. Particularly, when translating into multiple languages, the time and cost required may increase depending on the number of languages.

In this regard, translation tools based on artificial intelligence have recently been introduced. However, in the case of translation tools, the amount of translation that can be performed at the same time may be limited. Thus, a worker should repeat simple tasks for translation, and consistent translation results may not be provided to multiple translations. Furthermore, it may be difficult to provide optimized translation results for specific fields or specific companies.

Accordingly, there is a need for a method which can provide translation optimized for a specific field, based on a local rule corresponding to the specific field, can automate translation while saving considerable time and cost required when an expert or the like performs translation reflecting the local rule, can effectively improve the deterioration of translation quality that may appear when the translation reflecting the local rule is performed based on an artificial intelligence model or the like, can produce accurate translations while requiring fewer resources, and can efficiently perform multilingual translation for multiple languages. However, an appropriate solution thereto has not yet been presented.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a processor-implemented method including selecting, based on a given priority table, at least one unique expression set to be applied to a translation of original text from a local rule, the local rule including multiple types of unique expression sets, translating the original text by applying the at least one selected unique expression set to produce translated text, and updating the priority table, based on the produced translated text.

The multiple types of unique expression sets may include at least two among a word set, a term set, a domain set, and a sentence set.

The selecting may include selecting at least one artificial intelligence model corresponding to the at least one unique expression set to be applied to the translation of the original text.

The priority table may include a priority evaluation value of each of the multiple types of unique expression sets corresponding to multiple types of artificial intelligence models including the selected at least one artificial intelligence model.

The translating may include selecting a region corresponding to the at least one unique expression set from the original text, evaluating whether an expression in the selected region, corresponding to the at least one unique expression set, has been reflected in the translated text, and determining whether to retranslate the original text, based on a result of the evaluation.

The method may include retranslating the original text responsive to the determination to retranslate the text.

The retranslating may include producing revised translated text by reflecting the expression corresponding to the at least one unique expression set in a non-reflected region in the translated text that does not reflect the expression corresponding to the unique expression set and retranslating the original text in consideration of the revised translated text.

The retranslating may include determining whether a number of times the translated text is retranslated exceeds a predetermined number of times and determining whether an evaluation value of whether the expression corresponding to the at least one unique expression set has been reflected in the translated text meets a predetermined threshold.

In the updating, the priority table may be updated based on an evaluation value of whether the expression corresponding to the at least one unique expression set has been reflected in the translated text.

The translating may include a forward translation for translating the original text from a source language of the original text into a target language to produce first translated text, a backward translation for translating the first translated text from the target language into the source language to produce first retranslated text, and verifying the produced translated text, based on the original text and the first retranslated text.

The forward translation may include a first forward translation for translating the original text from a source language of the original text into a target language to directly produce first translated text and a second forward translation for translating the original text from the source language into an intermediate translation language to produce first intermediate translated text, and translating the first intermediate translated text from the intermediate translation language into the target language to produce second translated text, and the backward translation may include a first backward translation for translating the first translated text from the target language into the source language to directly produce the first retranslated text and a second backward translation for translating the second translated text from the target language into the intermediate translation language to produce second intermediate translated text, and translating the second intermediate translated text from the intermediate translation language into the source language to produce second retranslated text.

The verifying may be performed based on at least two of the original text, the first retranslated text, and the second retranslated text to produce translated text of the original text.

The verifying may include translating the original text again responsive to the verifying not being satisfied.

The verifying may include calculating a first similarity between the original text and the first retranslated text and a second similarity between the original text and the second retranslated text and comparing the first similarity and the second similarity with a predetermined similarity threshold.

In the verifying, the similarity threshold may be applied differently depending on a category of the original text to be translated.

In a general aspect, here is provided a device including one or more processors configured to execute instructions and a memory storing the instructions, and an execution of the instructions configures the one or more processors to select, based on a given priority table, at least one unique expression set to be applied to a translation of an original text from a local rule that includes multiple types of unique expression sets, translate the original text by applying the at least one selected unique expression set to produce translated text, and update the priority table, based on the produced translated text.

The selecting may include selecting at least one artificial intelligence model corresponding to the at least one unique expression set to be applied to the translation of the original text.

The priority table may include a priority evaluation value of each of the multiple types of unique expression sets corresponding to multiple types of artificial intelligence models including the selected at least one artificial intelligence model.

The translating may include translating the original text from a source language of the original text into a target language to produce first translated text, translating the first translated text from the target language into the source language to produce first retranslated text, and verifying the translated text, based on the original text and the first retranslated text.

In a general aspect, here is provided a computer-readable storage medium storing instructions that are configured to, when executed by a processor, cause a device, including a processor and translates given original text, to implement specific operations, the specific operations including selecting, based on a given priority table, at least one unique expression set to be applied to the translation of the original text from a local rule that includes multiple types of unique expression sets, translating the original text by applying the at least one selected unique expression set to produce translated text, and updating the priority table, based on the produced translated text.

### BRIEF DESCRIPTION OF THE DRAWINGS

FIG. 1 illustrates the configuration of a translation automation system according to one embodiment of the present disclosure;

FIG. 2 is a flowchart illustrating a translation automation method according to one embodiment of the present disclosure;

FIG. 3 illustrates the configuration and operation of a translation automation device according to one embodiment of the present disclosure;

FIGS. 4 and 5 illustrate the specific configuration and operation of a priority table in a translation automation system according to one embodiment of the present disclosure;

FIG. 6 illustrates a specific flowchart regarding the steps of producing translated text in a translation automation method according to one embodiment of the present disclosure;

FIG. 7 illustrates a specific flowchart regarding the steps of performing retranslation in a translation automation method according to one embodiment of the present disclosure;

FIG. 8 illustrates a specific flowchart regarding the steps of performing retranslation in a translation automation method according to one embodiment of the present disclosure;

FIGS. 9 and 10 are flowcharts illustrating specific operations of a translation automation device according to one embodiment of the present disclosure;

FIG. 11 illustrates the specific configuration and operation of a local rule and a dataset in a translation automation device according to one embodiment of the present disclosure;

FIG. 12 is a flowchart illustrating a translation automation method according to one embodiment of the present disclosure;

FIG. 13 illustrates a specific flowchart of a forward translation step in a translation automation method according to one embodiment of the present disclosure;

FIG. 14 illustrates a specific flowchart of a backward translation step in a translation automation method according to one embodiment of the present disclosure;

FIG. 15 illustrates the configuration and operation of a translation automation device according to one embodiment of the present disclosure;

FIG. 16 is a flowchart illustrating specific operations of a translation automation device according to one embodiment of the present disclosure;

FIGS. 17A to 17C specifically illustrate translation processes of a translation automation device according to one embodiment of the present disclosure; and

FIG. 18 illustrates the configuration of a computing device according to one embodiment of the present disclosure.

Throughout the drawings and the detailed description, unless otherwise described or provided, the same, or like, drawing reference numerals may be understood to refer to the same, or like, elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Advantages and features of the present disclosure and methods of achieving the advantages and features will be clear with reference to embodiments described in detail below together with the accompanying drawings. However, the present disclosure is not limited to the embodiments disclosed herein but will be implemented in various forms. The embodiments of the present disclosure are provided so that the present disclosure is completely disclosed, and a person with ordinary skill in the art can fully understand the scope of the present disclosure. The present disclosure will be defined only by the scope of the appended claims. Meanwhile, the terms used in the present specification are for explaining the embodiments, not for limiting the present disclosure.

Terms, such as first, second, A, B, (a), (b) or the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

Throughout the specification, when a component is described as being “connected to,” or “coupled to” another component, it may be directly “connected to,” or “coupled to” the other component, or there may be one or more other components intervening therebetween. In contrast, when an element is described as being “directly connected to,” or “directly coupled to” another element, there can be no other elements intervening therebetween.

In a description of the embodiment, in a case in which any one element is described as being formed on or under another element, such a description includes both a case in which the two elements are formed in direct contact with each other and a case in which the two elements are in indirect contact with each other with one or more other elements interposed between the two elements. In addition, when one element is described as being formed on or under another element, such a description may include a case in which the one element is formed at an upper side or a lower side with respect to another element.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

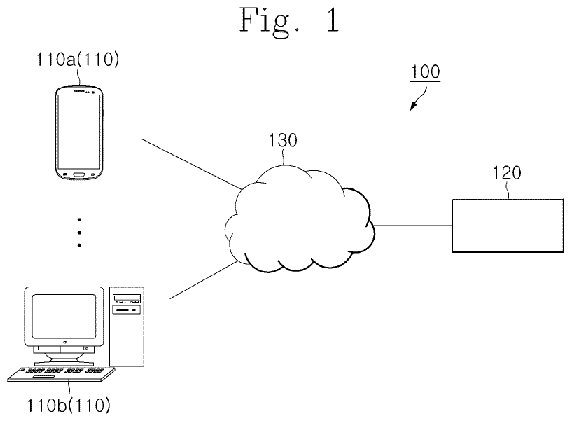

FIG. 1 illustrates the configuration and operation of a translation automation system 100 according to one embodiment of the present disclosure. As illustrated in FIG. 1, the translation automation system 100 according to one embodiment of the present disclosure may include one or more terminals 110a and 110b through which a user can input original text to be translated or perform a setting task for translation, and a translation automation device 120 capable of translating the given original text and providing the translation.

In this case, various terminals such as a personal computer (PC), a notebook PC, a tablet PC, a smartphone, a PDA, etc. may be used as the terminals 110a and 110b, but the present disclosure is not necessarily limited thereto. Additionally, various other devices that can be linked with a user's device to provide the translation automation system 120 with original text to be translated or information necessary for performing translation may be used as the terminals 110a and 110b.

Furthermore, the translation automation system 120 may be implemented as a system capable of translating given original text by using one or more physical server devices. However, the present disclosure is not necessarily limited thereto. The translation automation system 120 may also be configured using a personal computing device such as a desktop computer, a laptop, a tablet, or a smartphone, may be configured based on a cloud system, or further may be implemented in various forms, including a dedicated device.

Furthermore, it is possible to implement the terminals 110a and 110b and the translation automation device 120 in a combined form as a single server or device.

Furthermore, a network 130 connecting the terminals 110a and 110b to the translation automation device 120 in FIG. 1 may be a wired network or a wireless network, and may include various communication networks such as a local area network (LAN), a metropolitan area network (MAN), and a wide area network (WAN). In addition, the network 130 may include the known World Wide Web (WWW). Furthermore, the network 130 may be implemented using a data bus, or the like, configured to transmit and receive data, etc.

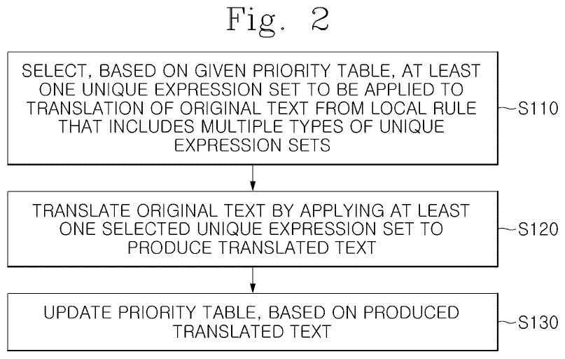

FIG. 2 illustrates a flowchart of a translation automation method according to one embodiment of the present disclosure.

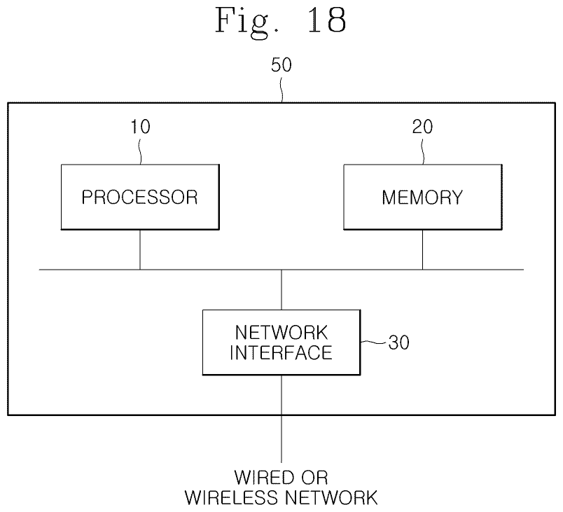

Here, the method illustrated in FIG. 2 may be performed by, for example, a translation automation device 120, and furthermore, the translation automation device 120 may be implemented as including a computing device 50 in FIG. 18 and the description made later with reference to FIG. 18. For example, the translation automation device 120 may include a processor 10, and the processor 10 may execute instructions configured to implement operations for translating given original text.

More specifically, as illustrated in FIG. 2, the translation automation method according to one embodiment of the present disclosure is a method for translating given original text by using the computing device 50, such as the translation automation device 120, and may include: a step S110 of selecting, based on a given priority table, at least one unique expression set to be applied to the translation of the original text from a local rule that includes multiple types of unique expression sets; a step S120 of translating the original text by applying the at least one selected unique expression set to produce translated text; and a step S130 of updating the priority table based on the produced translated text based on the produced translated text.

Here, the multiple types of unique expression sets included in the local rule may include at least two of a word set, a term set, a domain set, and a sentence set.

Furthermore, in the selecting step S110, at least one artificial intelligence model corresponding to the at least one unique expression set to be applied to the translation of the original text may be selected.

In this case, the priority table may include a priority value of each of the multiple types of unique expression sets corresponding to multiple types of artificial models.

Furthermore, the step S120 of producing the translated text may include a step S121 of selecting a region corresponding to the at least one unique expression set from the original text, a step S122 of evaluating the extent to which an expression in the selected region, corresponding to the at least one unique expression set, has been reflected in the translated text, and a step S123 of determining whether to retranslate the original text, based on the evaluation result.

Furthermore, the step S120 of producing the translated text may further include a step S124 of retranslating the original text.

Furthermore, the retranslating step S124 may include: a step S1241 of producing a revised translated text by reflecting the expression corresponding to the at least one unique expression set in a non-reflected region in the translated text that does not reflect the expression corresponding to the unique expression set; and a step S1242 of retranslating the original text in consideration of the revised translated text.

Furthermore, the retranslating step S1242 may include: a step S12421 of determining whether the number of times the translated text is retranslated exceeds a predetermined number of times; and a step S12422 of determining whether the evaluation value of the extent to which the expression corresponding to the at least one unique expression set has been reflected in the translated text meets a predetermined threshold.

Further, in the updating step, the priority table may be updated based on the evaluation value of the extent to which the expression corresponding to the at least one unique expression set has been reflected in the translated text.

Accordingly, the method, the device, the system, and the computer program for local rule-based translation automation may provide translation optimized for a specific field, based on a local rule, may automate translation while reducing significant time and cost that is required when an expert or the like performs translation reflecting the local rule, and furthermore, may effectively reduce translation quality deterioration that may occur when the translation reflecting the local rule is performed based on an artificial intelligence models or the like.

Hereinafter, the method for local rule-based translation automation and configurations and operations of the device and the system 100 for local rule-based translation automation, according to one embodiment of the present disclosure, will be described in more detail with reference to respective drawings.

First, in the step S110, the computing device 50, such as the translation automation device 120, selects, based on a given priority table, at least one unique expression set to be applied to translation of original text from a local rule containing multiple types of unique expression sets.

In this case, a user may request the translation automation device 120 or the like to translate original text in various ways, such as by inputting, via the terminal 110 or the like, the original text such as a text file to be translated or designating a file or the like stored in a server or a database.

Here, the original text may include at least one sentence or paragraph. However, the present disclosure is not necessarily limited thereto, and in the present disclosure, the original text may broadly include at least one word or term.

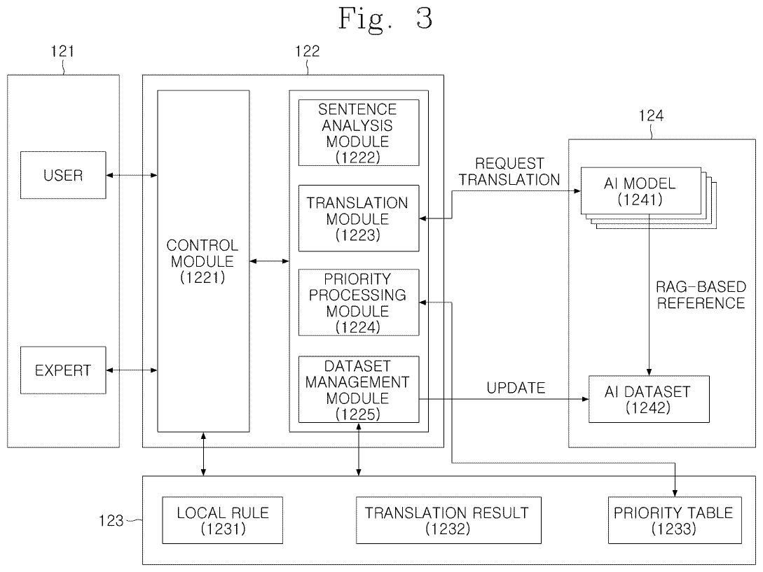

More specifically, referring to FIG. 3, the translation automation device 120 according to one embodiment of the present disclosure may include an input unit 121, a translator 122, a storage unit 123, and an artificial intelligence model unit 124. However, the present disclosure is not necessarily limited thereto, and it is possible to implement the translation automation device 120 in various ways, such as by omitting some of the components or combining at least two components.

Accordingly, the input unit 121 of the translation automation device 120 may receive original text provided or designated by the user, and provide the original text to the translator 122.

More specifically, the user may provide, via the input unit 121, original text such as a web page or a manual regarding a service to be translated, or perform a setting task for translation. Furthermore, some users such as a translation expert may receive an evaluation or feedback on translated text from the translator 122, and perform a task to improve the quality of translation by the translator 122.

Accordingly, the translator 122 of the translation automation device 120 may translate the given original text to produce translated text and provide the translated text to the user.

More specifically, a control module 1221 of the translator 122 may receive information about the original text transmitted from the input unit 121 and provide the information to a sentence analysis module 1222, a translation module 1223, a priority processing module 1224, and a dataset management module 1225, or may perform operations to control the operation of each module.

Accordingly, the sentence analysis module 1222 may parse or analyze the original text to be translated, and then the translation module 1223 may perform translation based on a priority to be applied in the translation process by reflecting a weight or the like based on the analysis result.

In this case, the priority processing module 1224 may calculate a priority for translation of the original text by referring to a priority table 1233 stored in the storage unit 123, and the dataset management module 1225 may provide a translation result 1232, such as translated text translated from the original text, to the storage unit 123 for storage and manage the translation result by reflecting the translation result in an artificial intelligence dataset 1242, etc.

In addition, the storage unit 123 may store and manage a local rule 1231 that is input by the user or transmitted from a server or a database, or may store and manage the translated result 1232, such as translated text produced by the translator 122, and may store and manage the priority table 1233 to improve the accuracy of a translation task.

Furthermore, the artificial intelligence model unit 124 may provide various artificial intelligence models 1241, such as generative artificial intelligence models, that can be used for translation, and may also have the artificial intelligence dataset 1242 customized for a service domain so that the artificial intelligence models 1241 can reference the artificial intelligence dataset 1242 to perform translation task based on retrieval-augmented generation (RAG).

Furthermore, the artificial intelligence dataset 1242 may include the local rule 1231 and the translation result 1232, and the local rule 1231 and the translation result 1232 in the artificial intelligence dataset 1242 may be updated via the dataset management module 1225.

Accordingly, in the step S110, the translator 122 may select, based on a given priority table, at least one unique expression set to be applied to translation of the original text from the local rule including multiple types of unique expression sets.

In this case, the local rule 1231 according to one embodiment of the present disclosure may include multiple types of unique expression sets including unique terms, expressions, etc. to be applied in the process of producing the translated text of the given original text.

More specifically, the local rule 1231 may be implemented as a dictionary or the like that contains unique terms, expressions, etc. that are used as standard by a specific company or in a specific service or software.

For example, the multiple types of unique expression sets included in the local rule 1231 may include at least two of the following: a word set, a term set, a domain set, and a sentence set.

Here, a word may be a constituent unit of an expression forming a term, such as “query”, “backup”, etc., and a domain may be an expression that defines a characteristic, such as a data attribute, length, format, etc., like start date (StartDt), type, date (Dt), etc.

On the other hand, a term may be defined as an expression that combines {0 or 1 or more} words and a domain, and thus every term has a structure of word(s) (0 or n)+domain.

When registering a term, if it is necessary to refer to existing words, it is possible to separate the words with a space (spacing), and if the term is registered as a single word, it is possible to remove the space (spacing) and register the words as the single word.

In a more specific example, “word start date” (Query StartDt), which combines the word “query” and the domain “start date”, “query date” (Query Dt), which combines “query” and “date”, etc. may be registered and included in the term set.

Furthermore, a sentence is an expression including one or more clauses, and may typically include a subject and a verb.

Accordingly, the local rule 1231 may have multiple types of unique expression sets, such as a word set, a term set, a domain set, and a sentence set, and the translator 122 may select, from the local rule 1231, at least one unique expression set to be applied to translation of the original text.

In a more specific example, when the original text “ [symbol] [symbol] ” is translated, the original text may be generally translated as “display a screen”. However, a specific company A uses the unique expression “display a page” for this purpose, the local rule 1231 may register a word set or a sentence set to translate “screen” as “page”, and the translator 122 may accordingly select the word set or the sentence set from the local rule 1231 to apply the word set or the sentence set to the translation of the original text.

In this regard, the priority table 1233 may include priority-related information, such as an evaluation value of a unique expression set that may be applied to translation of given original text among multiple types of unique expression sets.

Accordingly, the translator 122 may select at least one unique expression set to be applied to the translation of the original text, based on the priority table 1233.

Furthermore, the priority table 1233 may include a priority evaluation value of each of multiple types of unique expression sets corresponding to multiple types of artificial intelligence models.

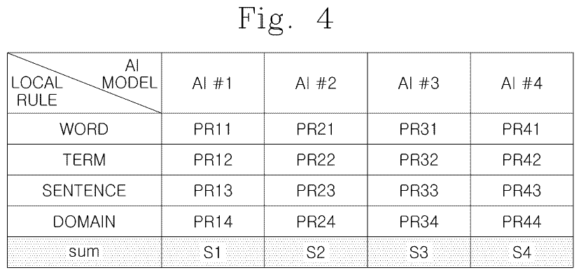

In a more specific example, as illustrated in FIG. 4, the priority table 1233 may include priority evaluation values (PR11 to PR44 in FIG. 4) corresponding to a word set, a term set, a sentence set, and a domain set for four artificial intelligence models (AI #1 to AI #4 in FIG. 4).

In this case, each priority evaluation value may be calculated based on a unique expression correspondence evaluation value (AR) and an expert evaluation value (ER) for the translation results produced by the artificial intelligence models, and furthermore, may be calculated as in Equation 1 below in consideration of an artificial intelligence model evaluation weight (AW) for the unique expression correspondence evaluation value (AR) and an expert evaluation weight (EW) for the expert evaluation value (ER).

$$Priority Evaluation Value ( PR ) = Unique Expression Correspondence Evaluation Value ( AR ) * AI Model Evaluation Weight ( AW ) + Expert Evaluation Weight ( ER ) * Expert Evaluation Weight ( EW ) \qquad Equation 1$$

However, this is one embodiment of the present disclosure, and the present disclosure is not necessarily limited thereto. Moreover, it is possible to calculate the priority evaluation value (PR) in various other ways.

Furthermore, in the priority table 1233, the sum of priority evaluation values (sum in FIG. 4) may be normalized to 1, and accordingly, each priority evaluation value may be converted according to the percentage thereof.

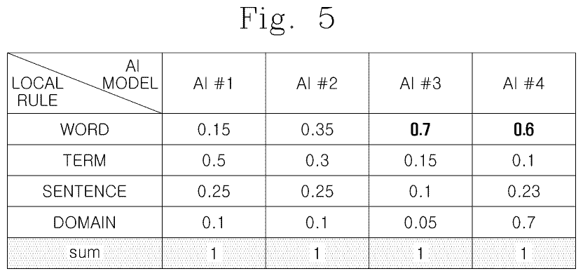

In a more specific example, FIG. 5 illustrates the priority table 1233 constructed based on a unique expression set of the specific company A.

As illustrated in FIG. 5, one or more unique expression sets may be selected from the priority table 1233 in order of high priority evaluation values, and it is also possible to simultaneously select an artificial intelligence model corresponding to each unique expression set to be applied to the translation of the original text.

In a more specific example, referring to FIG. 5, it is possible to select three cases: applying a word set based on artificial intelligence model number 3 (AI #3) (PR=0.7); applying a word set based on artificial intelligence model number 4 (AI #4) (PR=0.6); and applying a term set based on artificial intelligence model number 1 (AI #1) (PR=0.5).

Accordingly, in the step S120, the translation of the original text may be performed by applying the at least one selected unique expression set to produce translated text.

In the step S120, one or more artificial intelligence models 1241, such as generative artificial intelligence models, may be used to produce the translated text of the original text, but the present disclosure is not necessarily limited thereto.

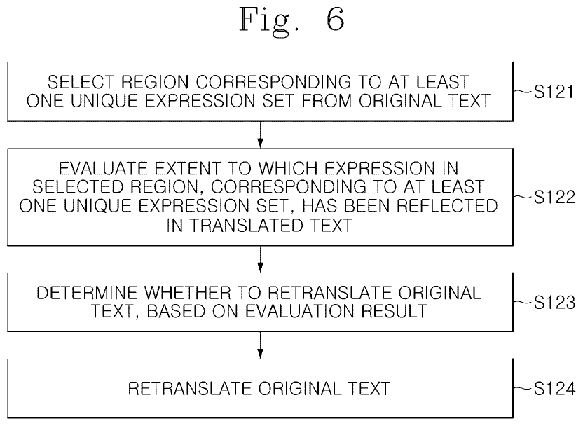

More specifically, as illustrated in FIG. 6, step S120 may include a step S121 of selecting a region corresponding to the at least one unique expression set from the original text, a step S122 of evaluating the extent to which an expression in the selected region, corresponding to the at least one unique expression set, has been reflected in the translated text, and a step S123 of determining whether to retranslate the original text, based on the evaluation result.

Furthermore, the step S120 may further include a step S124 of retranslating the original text, as illustrated in FIG. 6.

More specifically, in the step S121, given original text may be parsed, or a region corresponding to at least one unique expression set may be selected from the original text through a rule-based matching analysis, or the like.

For example, in the step S121, “ [symbol] ” included in a selected unique expression may be selected from original text “ [symbol] ”.

Then, in the step S122, the extent to which an expression in the selected region, corresponding to at least one unique expression set, has been reflected in the translated text of the original text is evaluated.

For example, in the step S122, it is identified whether the expression in the selected region, corresponding to the unique expression set, has been reflected in the translated text “display a screen” (in the above example, whether “ [symbol] ” has been translated into “page” is identified), and the percentage of expressions corresponding to the multiple unique expression sets that have been reflected in the translated text may be evaluated. That is, in an example, an evaluation of whether the expression has been reflected in the translated text is conducted.

Accordingly, in the step S123, whether to retranslate the original text may be determined based on the result of the evaluation.

For example, in the step S122, it may be identified whether the percentage of expressions corresponding to the multiple unique expression sets, reflected in the translated text of the given original text, meets a predetermined threshold (e.g., 95%), and if not, a determination may be made to retranslate the original text.

Accordingly, in the step S124, the original text may be retranslated.

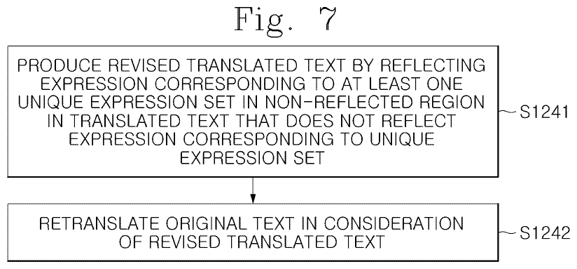

More specifically, as illustrated in FIG. 7, the step S124 may include a step S1241 of producing a revised translated text by reflecting the expression corresponding to the at least one unique expression set in a non-reflected region in the translated text that does not reflect the expression corresponding to the unique expression set, and a step S1242 of retranslating the original text in consideration of the revised translated text.

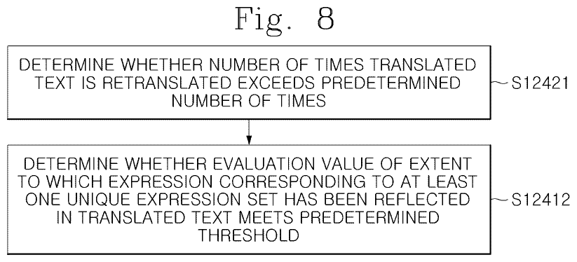

Furthermore, as illustrated in FIG. 8, the step S1242 may include a step S12421 of determining whether the number of times the translated text is retranslated exceeds a predetermined number of times, and a step S12422 of determining whether an evaluation value of the extent to which the expression corresponding to the at least one unique expression set has been reflected in the translated text meets a predetermined threshold.

More specifically, in the step S1241, a revised translated text may be produced by reflecting the expression corresponding to the at least one unique expression set in a non-reflected region in the translated text that does not reflect the expression corresponding to the unique expression set.

It is possible to perform generation, but the present disclosure is not necessarily limited thereto.

In a more specific example, in the step S1241, an unflected region “screen” that does not reflect the expression corresponding to the unique expression set may be selected from the translated text “display a screen”, and a revised translated text “display a page” may be produced by reflecting the expression corresponding to the unique expression set in the non-reflected region.

Subsequently, in the step S1242, the original text is retranslated in consideration of the revised translated text.

In the step S1242, it is possible to retranslate the original text by using one or more artificial intelligence models 1241, such as generative artificial intelligence models, but the present disclosure is not necessarily limited thereto.

In a more specific example, in the step S1242, the artificial intelligence models 1241 may be requested to translate the original text “ [symbol] [symbol] ” and simultaneously provided with the revised translated text “display a page” so as to retranslate the original text with reference to the revised translated text.

Subsequently, in the step S130, the priority table may be updated based on the produced translated text.

Furthermore, in the step S130, the priority table may be updated based on the evaluation value of the extent to which the expression corresponding to the at least one unique expression set has been reflected in the translated text.

Thus, in the present disclosure, it is possible to continuously improve translation accuracy while continuously updating the priority table by reflecting an evaluation value regarding the translated text produced with respect to the original text.

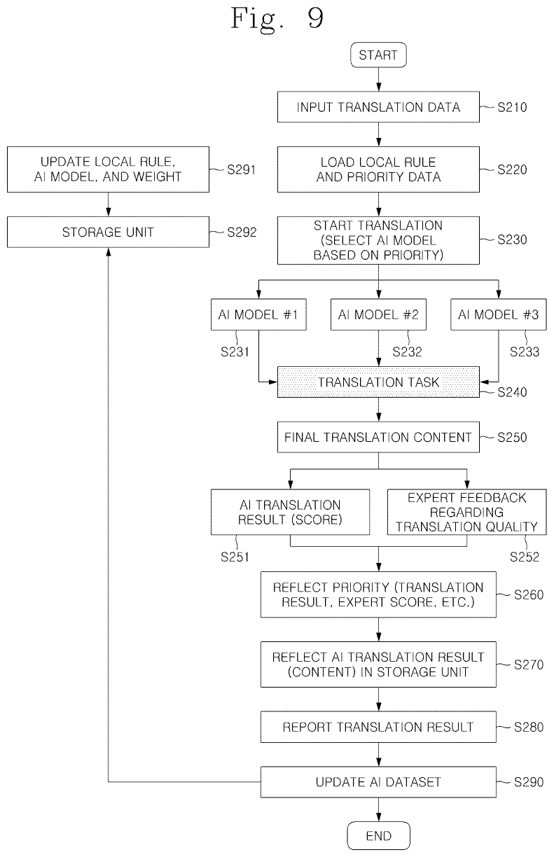

More specifically, FIG. 9 illustrates a flowchart of specific operations of the translation automation device 120 according to one embodiment of the present disclosure.

Referring to FIG. 9, the translation automation device 120 may first receive data, such as original text to be translated or settings or a local rule to be applied to translation, from a user or the like by using the input unit 121 or the like (S210).

Subsequently, the translation automation device 120 may collect data such as the local rules 1231, the priority table 1233, and the like from the storage unit 123 or the like (S220).

In this case, data corresponding to the top n rankings may be collected based on a predetermined or user-inputted number for translation.

Furthermore, when an artificial intelligence model 1241 is selected by a user or the like from the priority table 1233, it is possible to select a local rule to be applied based on local rule priority evaluation values in the environment of the artificial intelligence model 1241.

Next, the translation automation device 120 may select one or more artificial intelligence models 1241 to be applied to the translation of the original text from among multiple artificial intelligence models 1241, based on the priority table 1233 or the like (S230), and start the translation.

Furthermore, when the local rule priority evaluation values are the same, it is possible to select the local rule to be applied to the translation according to a predetermined order such as words, terms, domains, sentences, etc., and it is also possible to designate the order based on an index value.

Accordingly, the translation automation device 120 may perform a task of translating the original text (S240) by operating the one or more selected artificial intelligence models (AI model #1, AI model #2, or AI model #3 in the example of FIG. 9) in parallel (S231, S232, and S233).

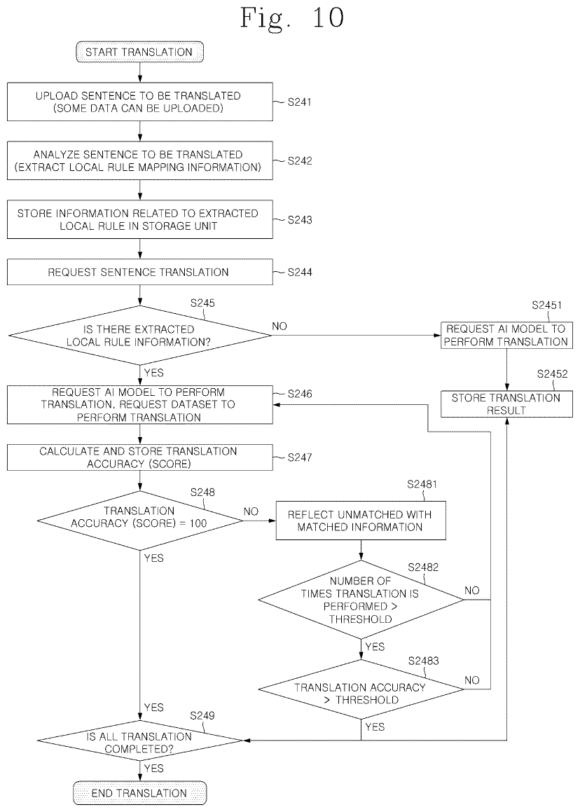

In this regard, FIG. 10 illustrates a specific flowchart of the translation task.

Accordingly, in the translation automation device 120, the original text such as a sentence to be translated may be uploaded (S241).

In this case, the entire manual or the like may be uploaded all at once as the original text to be translated, and may then be translated. However, the original text may be divided into certain sizes such as page units or paragraph units, and then uploaded or translated. Furthermore, it is possible to divide and translate the original text into sizes such as page units, etc. in order to effectively calculate the accuracy of the translation task and improve the translation accuracy of a translation result.

Subsequently, the translation automation device 120 may analyze the original text, such as a sentence to be translated, to extract local rule mapping information, etc. (S242).

In a more specific example, the translation automation device 120 may extract information mapped to a word, a term, a domain, or a sentence included in a local rule from the original text, such as the sentence to be translated.

In addition, the translation automation device 120 may store the extracted local rule-related information in a storage unit (S243).

Accordingly, the extracted local rule-related information, such as a local rule mapping ratio in the entire sentence, may be stored in the storage unit 123 and used while performing a translation task, and further, may be used in the final reporting process.

Next, the translation automation device 120 makes a translation request to one or more artificial intelligence models 1241 selected from among the multiple artificial intelligence models 1241 for translation of the original text (S244).

In this case, the translation automation device 120 identifies whether there is the local rule mapping information extracted during the translation sentence analysis process (S245).

When there is the local rule mapping information, the translation automation device 120 may request the artificial intelligence models 1241 to perform translation reflecting the artificial intelligence dataset 1242 (S246).

Accordingly, the artificial intelligence models 1241 may perform a translation task reflecting the artificial intelligence dataset 1242, based on retrieval-augmented generation (RAG).

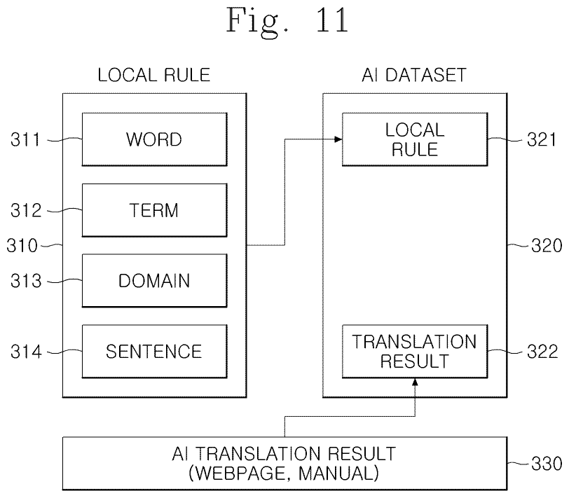

As illustrated in FIG. 11, an artificial intelligence dataset 320 may include a local rule 310 including a word set 311, a term set 312, a domain set 313, and a sentence set 314 collected from the storage unit 123 or the like. Furthermore, artificial intelligence dataset 320 may include a translation result 322 or the like collected from the storage unit 123 or the like, and may be used for RAG generation during the translation of the original text.

On the other hand, when there is no local rule mapping information, the artificial intelligence models 1241 may be requested to directly perform translation (S2451).

In this case, since there is no local rule to be mapped, the artificial intelligence model 1241 may be directly invoked to perform the translation without performing retrieval-augmented generation (RAG) regarding the artificial intelligence dataset 320, and the translation result may be stored in the storage unit 123 (S2452).

Further, when there is local rule mapping information and translation reflecting the artificial intelligence dataset 1242 is performed (S243), translation accuracy (score) may be calculated and stored (S247).

More specifically, when the translation of the original text is completed, the translation automation device 120 may identify whether the local rule mapping information has been properly reflected, and calculate translation accuracy based on the percentage of a local rule reflected. In this case, the translation accuracy may be converted to a percentage, with 100 as a maximum value.

Subsequently, the translation automation device 120 identifies whether the translation accuracy of the original text is 100 (i.e., identifies whether the local rule mapping information has been fully reflected without omission during the translation) (S248).

When the translation accuracy is not 100, the translation automation device 120 reflects correct mapping information in unmatched local rule information (S2481).

Subsequently, the translation automation device 120 repeatedly reflects the unmapped local rule information with the correct mapping information until the number of times translation has been performed reaches a predetermined threshold value, and performs a retranslation task based on the changed translation result (S2482).

Furthermore, the translation automation device 120 repeatedly performs the retranslation task while determining whether the calculated translation accuracy meets a predetermined threshold value (S2483).

Accordingly, the translation automation device 120 provides the original text to be translated, previous translated text of the original text, translated text obtained by reflecting unmapped local rule information in the previous translated text, etc. to the artificial intelligence models 1241 to perform a retranslation task (S246).

In this case, the retranslation task may be performed repeatedly until the number of times translation has been performed or the translation accuracy meets the predetermined threshold.

Accordingly, the translation automation device 120 determines whether the translation of the original text has been completed. When the translation of all sentences has not been completed, the translation automation device 120 performs a task of translating the next sentence to be translated, and repeatedly performs the translation task until there are no more sentences to be translated (S249).

Accordingly, referring again to FIG. 9, the translation automation device 120 may store the final translation results in the storage unit 123 (S250). In this case, an artificial intelligence translation result (score) may also be managed (S251).

In this case, the translation automation device 120 may calculate the artificial intelligence translation result (score) by accumulating the translation accuracy of the final translation results according to translation tasks, stored in the storage unit 123.

In addition, the translation automation device 120 may reflect expert feedback regarding the quality of translation together (S252).

In this case, the translation result or the like may be provided to and reviewed by the expert, and the translation automation device 120 may reflect the expert feedback or the like inputted via the input unit 121 or the like to adjust the artificial intelligence model 1241 or the like or to adjust the priority or the like of the translation automation system 100 as necessary.

More specifically, a translation expert may provide, via the input unit 121 or the like, feedback on the translation accuracy calculated based on the naturalness of a translation result, grammatical errors, etc., and the expert feedback may be converted into a score to reflect priorities, and then managed.

Next, the translation automation device 120 may calculate a priority based on the artificial intelligence translation result (score) and the expert score, and update the priority table or the like (S260).

In this case, when updating the priority table, a weight for each artificial intelligence model, a weight for each expert, etc. may be reflected.

Subsequently, the translation automation device 120 may reflect the artificial intelligence translation result (content) in the storage unit 123 (S270).

More specifically, the translation results requested from the artificial intelligence model may be stored for each translation task step, and the final translation result may be generated and stored based on the last translation result of each translation task. Furthermore, the final translation product may be managed together with the original text, such as a webpage or manual.

Accordingly, the translation automation device 120 may perform reporting on the translation result (S280).

In this case, the translation automation device 120 may score and record the level of the translation result to be reportable, and based on this, determine the trend of translation accuracy and reflect the determined trend in the priority weighting.

Additionally, the translation automation device 120 may update the artificial intelligence dataset 1242 (S290).

More specifically, the final translation result 1232 stored in storage unit 123 may be provided to and stored in the artificial intelligence dataset 1242, thereby further improving translation accuracy in the next translation task, based on the artificial intelligence dataset 1242.

Furthermore, the local rule may be updated at any time by the user or the like, and may also be stored in the artificial intelligence dataset 1242 and used for training or the like.

In the present disclosure, local rule 1231 data may be periodically updated in the artificial intelligence dataset 1242, based on translation results by the artificial intelligence models and expert review results, so that translation accuracy can be continuously improved over time through artificial intelligence learning, and the artificial intelligence models can better understand and apply new terms, sentence structures, and modes of expression.

The translation automation device 120 may also update the local rule 1231, the artificial intelligence models 1241, and the weights. In this case, the local rules 1231, the artificial intelligence models, and the weight information may be updated by a user or a system.

Further, the translation automation device 120 may store information about the local rule 1231, the weights, the artificial intelligence models, and the translation result 1232 in the storage unit 123 (S292).

Accordingly, in the present disclosure, it is possible to provide a service domain-specific translation result that accurately reflects translation process automation and a local rule.

In this case, it is possible to: eliminate the manual work and modification process required in the translation process; significantly reduce the time and cost of translation tasks; and furthermore, improve the accuracy and consistency of translation, while enabling smooth expansion to various languages.

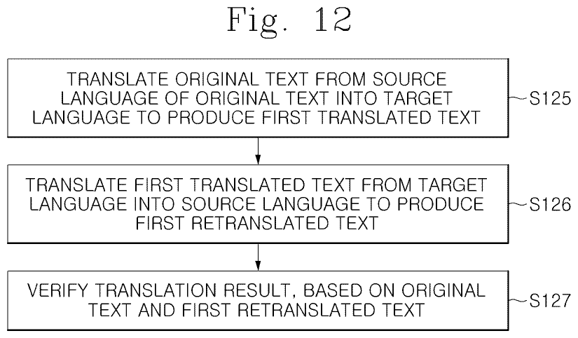

Furthermore, FIG. 12 illustrates a flowchart of a translation automation method according to a second embodiment of the present disclosure.

Here, the method illustrated in FIG. 12 may be performed, for example, by a translation automation device 120, and furthermore, the translation automation device 120 may be implemented including a computing device 50 in FIG. 18 and a description made with reference to FIG. 18. For example, the translation automation device 120 may include a processor 10, wherein the processor 10 may execute instructions configured to implement operations for translating given original text.

More specifically, as illustrated in FIG. 12, a translation automation method according to one embodiment of the present disclosure is a method for translating given original text by using the computing device 50 such as the translation automation device 120. The translation automation method may include: a forward translation step S125 of translating the original text from a source language of the original text into a target language to produce first translated text; a backward translation step S126 of translating the first translated text from the target language into the source language to produce first retranslated text; and a step S127 of verifying the translation result, based on the original text and the first retranslated text.

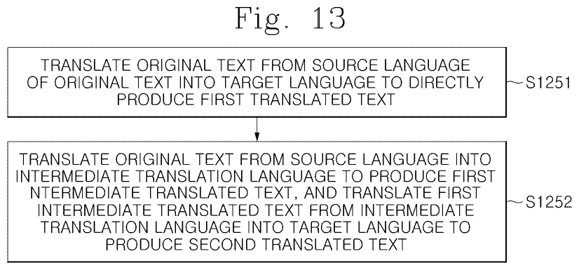

Here, as illustrated in FIG. 13, the forward translation step S125 may include: a first forward translation step S1251 of translating the original text from a source language of the original text into a target language to directly produce first translated text; and a second forward translation step S1252 of translating the original text from the source language into an intermediate translation language to produce first intermediate translated text, and translating the first intermediate translated text from the intermediate translation language into the target language to produce second translated text.

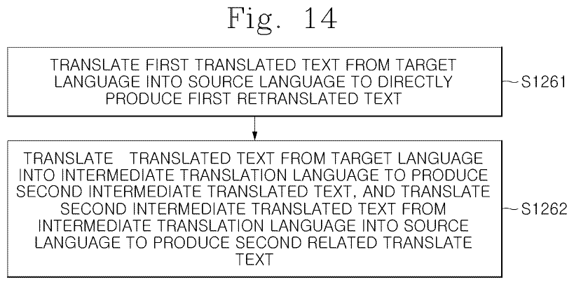

Furthermore, as illustrated in FIG. 14, the backward translation step S126 may include: a first backward translation step S1261 of translating the first translated text from the target language into the source language to directly produce first retranslated text; and a second backward translation step S1262 of translating the second translated text from the target language into the intermediate translation language to produce second intermediate translated text, and translating the second intermediate translated text from the intermediate translation language into the source language to produce a second related translated text.

Further, in verifying step S127, the verification may be performed based on at least two of the original text, the first retranslated text, and the second retranslated text to produce translated text of the original text.

Furthermore, in the verifying step S127, when the verification of the translation result is not satisfied, the translation of the original text may be performed again.

Furthermore, in the verifying step S127, the translation result may be verified by calculating first similarity between the original text and the first retranslated text and second similarity between the original text and the second retranslated text and comparing the first similarity and the second similarity with a predetermined similarity threshold.

Furthermore, in the verifying step S127, the similarity threshold may be applied differently depending on the category of the original text to be translated.

Furthermore, the method illustrated in FIG. 12 may be included in the step S120 of producing translated text in the translation automation method in FIG. 2 described above, and used to produce translated text of the original text. However, the present disclosure is not necessarily limited thereto, and the method illustrated in FIG. 12 may be independently used to translate given original text regardless of the translation automation method in FIG. 2.

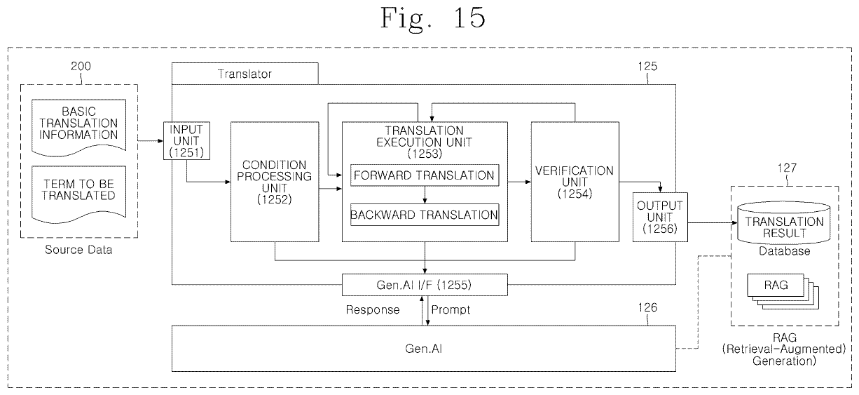

In this regard, FIG. 15 illustrates the configuration and operation of a translation automation device 120 when the translation automation method in FIG. 12 is used independently.

Hereinafter, a translation automation method and the specific operation and configuration of a translation automation device according to one embodiment of the present disclosure will be described with reference to FIGS. 12 to 15.

First, as illustrated in FIG. 15, the translation automation device 120 according to one embodiment of the present disclosure may include a translator 125, an artificial intelligence model unit 126, and a storage unit 127.

Furthermore, as illustrated in FIG. 15, the translator 125 may include an input unit 1251, a condition processing unit 1252, a translation execution unit 1253, a verification unit 1254, an artificial intelligence model interface unit 1255, and an output unit 1256.

The input unit 1251 may receive, via the user's terminal 110 or the like, basic information necessary for performing translation (e.g., a source language of the original text (e.g., Korean, etc.), a target language to be translated (e.g., Vietnamese, etc.), user-related information, information related to translation difficulty, etc.), and the original text to be translated, including words, terms, sentences, etc.

Accordingly, the condition processing unit 1252 may provide and recommend verification conditions, etc. for the translated text of the original text.

More specifically, in the present disclosure it is possible to produce translated text (e.g., Vietnamese) of the original text (e.g., Korean) through forward translation, produce retranslated text (e.g., Korean) of the translated text (e.g., Vietnamese) through backward translation, and then verify whether the translation is properly performed, based on the similarity between the original text and the retranslated text.

In the present disclosure, the verification may be performed by applying different similarity thresholds, depending on the category of the original text (e.g., medical field, financial field, etc.), and the condition processing unit 1252 may calculate and provide a similarity threshold for verification of the translated text of the original text by using the artificial intelligence model unit 126 or the like.

Furthermore, the translation execution unit 1253 translates given original text.

As a more specific example, in the present disclosure, the translation execution unit 1253 may perform the following four translation processes by using the artificial intelligence model unit 126 and the like.

(First forward translation) Translate original text S from a source language into a target language to directly produce first translated text T1.

(Second forward translation) Translate the original text(S) from the source language into an intermediate translation language to produce first intermediate translated text M1, and translate the first intermediate translated text M1 from the intermediate translation language into the target language to produce second translated text (T2).

(First backward translation) Translate the first translated text T1 from the target language into the source language to directly produce first retranslated text RS1.

(Second forward translation) Translate the second translated text T2 from the target language into the intermediate translation language to produce second intermediate translated text M2, and translate the second intermediate translated text M2 from the intermediate translation language into the source language to produce second retranslated text RS2.

However, in the present disclosure, the translation execution unit 1253 is not necessarily required to perform all of the four translation processes, and may perform translation in various other ways.

Accordingly, the verification unit 1254 may perform verification based on at least two of the original text S, the first retranslated text RS1, and the second retranslated text RS2, and produce the translated text of the original text, based on the verification.

In a more specific example, the verification unit 1254 may calculate the similarity between the original text S and the first retranslated text RS1, calculate the similarity between the original text S and the second retranslated text RS2, and compare the calculated similarity with a predetermined similarity threshold to verify whether the translation requirement level is met, and then collect the items with the highest similarity for each translation item (e.g., word, term, sentence, etc.) to form a translation result set and provide the translation result set.

Accordingly, the output unit 1256 may store the verified translation results in the storage unit 127, and may provide the verified translation results in response to a user's request or the like.

Furthermore, in the translation automation device 120 according to one embodiment of the present disclosure, it is possible to pre-train generative artificial intelligence of artificial intelligence models (126) through retrieval-augmented generation (RAG), with respect to the criteria for determining whether the translation requirement level for performing the translation is met, a terminology dictionary for industry according to the category of the original text, an abbreviation dictionary, etc.

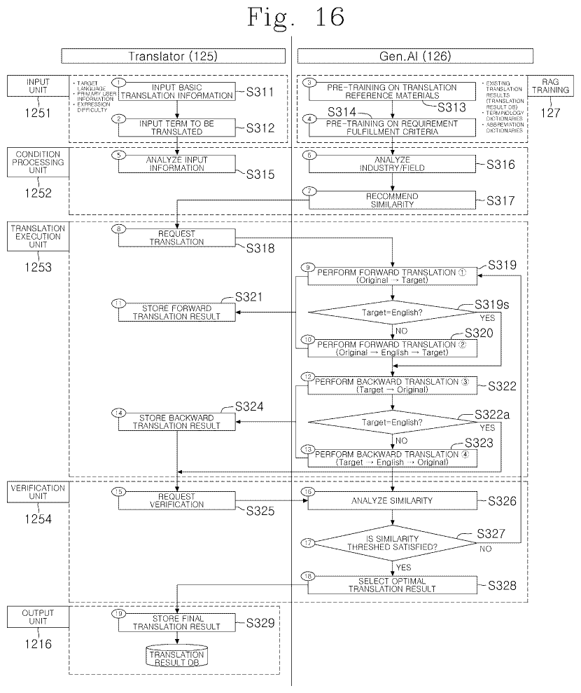

In this regard, FIG. 16 illustrates a flowchart showing specific operations of the translation automation device 120 according to one embodiment of the present disclosure.

First, as illustrated in FIG. 16, the input unit 1251 of the translator 125 in the translation automation device 120 may receive basic translation information necessary for performing translation, such as a source language of original text (e.g., Korean, etc.), a target language to be translated (e.g., Vietnamese, etc.), user-related information, and information related to translation difficulty via a user's terminal 110 or the like (S311).

Furthermore, the input unit 1251 may receive the original text to be translated, including words, terms, sentences, etc. to be translated, (S312).

More specifically, the input unit 151 may receive the original text to be translated, by using various input methods, such as user input, transmission from another system, a database, and a function call in a program, and may also receive the original text to be translated, in various forms such as text input, file transmission, and database linkage.

Furthermore, the artificial intelligence model unit 126 of the translation automation device 120 may perform pre-training on materials such as existing translation results (translation result databases), terminology dictionaries for industries and the like, abbreviation dictionaries, and user-defined glossaries, which can be referenced during translation (S313).

Furthermore, in the translation automation device 120, the artificial intelligence model unit 126 may also be pre-trained on translation requirement level fulfillment criteria for determining whether the translation result is appropriate (S314).

In this regard, the condition processing unit 1252 of the translation automation device 120 analyzes the input translation basic information and the original text to be translated, such as words, terms, sentences, etc. to be translated (S315).

Then, based on the analysis result, the condition processing unit 1252 analyzes categories such as industries or fields corresponding to the original text to be translated (S316).

Accordingly, the condition processing unit 1252 may calculate and recommend criteria for determining whether the translation requirement level is met, such as a similarity threshold to be applied to verification of the translation result, based on the result of the analysis of the categories such as industries or fields (S317).

In a more specific example, the condition processing unit 1252 may recommend a similarity threshold according to the field of the original text to be translated, such as 95% for the medical/legal field, 90% for the financial field, 85% for the general field.

Accordingly, the translation automation device 120 may request the generative artificial intelligence of the artificial intelligence model unit 126 to translate the original text (S318).

More specifically, the translation automation device 120 may perform forward translation as follows by using the artificial intelligence model unit 126 and the like.

(First forward translation) Translate original text S from a source language into a target language to directly produce first translated text T1 (S319).

(Second forward translation) Translate the original text(S) from the source language into an intermediate translation language (e.g., English) to produce first intermediate translated text M1, and translate the first intermediate translated text M1 from the intermediate translation language into the target language to produce second translated text T2 (S320).

In this case, English, etc., which has excellent translation performance for various languages, may be used as the intermediate translation language, but the present disclosure is not necessarily limited thereto.

Furthermore, in the present disclosure, when the target language is the same as the intermediate translation language (for example, when translating Korean into English), it is possible to omit the (second forward translation) (S319a).

Accordingly, the translation results of the (first forward translation) and the (second forward translation) are stored in the storage unit 127 or the like (S321).

In addition, the translation automation device 120 may perform backward translation as follows by using the artificial intelligence model unit 126 or the like.

(First backward translation) Translate the first translated text T1 from the target language into the source language to directly calculate first retranslated text RS1 (S322).

(Second backward translation) Translate the second translated text T2 from the target language into the intermediate translation language to produce second intermediate translated text M2, and translate the second intermediate translated text M2 from the intermediate translation language into the source language to produce second retranslated text RS2 (S323).

Furthermore, in the present disclosure, when the target language is the same as the intermediate translation language (for example, when translating Korean to English), it is possible to omit the (second backward translation) (S322a).

Subsequently, the translation results of the (first backward translation) and the (second backward translation) are stored in the storage unit 127 or the like (S324).

Next, the verification unit 1254 of the translation automation device 120 requests verification using similarity analysis or the like in order to identify the reliability level of the translation result (S325).

Accordingly, the artificial intelligence model unit 126 performs similarity analysis on the translation result by using a generative artificial intelligence model (S326).

In this case, a technique (e.g., cosine similarity, Lemma similarity, or TF-IDF) to be applied for similarity analysis of the translation result may be determined by a generative artificial intelligence model or the like by reflecting the characteristics of a category such as an industry or field of the original text to be translated, or may be directly configured by a user via the terminal 110 or the like.

Accordingly, it is determined whether the result of the similarity analysis meets the similarity threshold according to a predetermined industry or field (S327).

In this case, when the result of the similarity analysis does not meet the similarity threshold, the translation task for the original text may be performed again.

Subsequently, an optimal translation result may be selected based on the translation result (S328).

In a more specific example, it is possible to compare similarity calculation results of the translation results of direct translation such as (first forward translation) and (first backward translation) and indirect translation such as (second forward translation) and (second backward translation), and select an optimal translation result with high similarity for each item to be translated.

Accordingly, the output unit 1256 of the translation automation device 120 may store the final translation result in the translation result database of the storage unit 127 (S329).

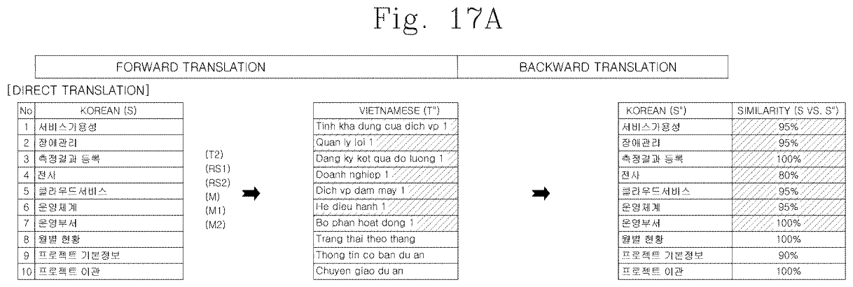

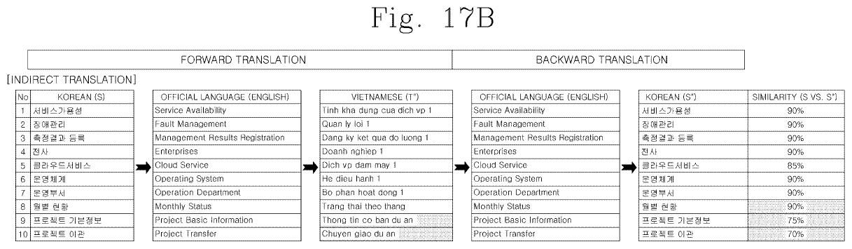

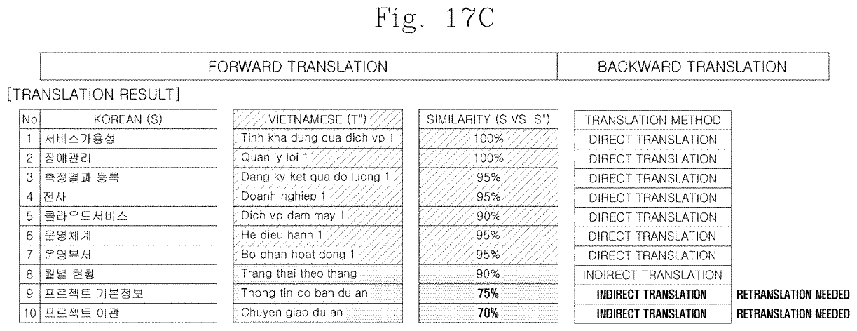

In this regard, FIGS. 17A to 17C illustrate examples of translating original text (10 words) in a source language (Korean) into translated text in a target language (Vietnamese) in the present disclosure.

More specifically, FIG. 17A illustrates an example of direct translation of (first forward translation) and (first backward translation) in which 10 Korean terms are translated into 10 Vietnamese terms.

Accordingly, as illustrated in FIG. 17A, the similarity between the original text S of the 10 terms and first retranslated text RS1 by the direct translation may be calculated (similarity (S vs. RS1) in FIG. 17A).

Furthermore, FIG. 17B illustrates indirect translation of (second forward translation) and (second backward translation) in which 10 Korean terms are translated into 10 Vietnamese terms.

Accordingly, as illustrated in FIG. 17B, the similarity between the original text S of the 10 terms and second retranslated text RS2 by the indirect translation may be calculated (similarity (S vs. RS2) in FIG. 17B).

Subsequently, as illustrated in FIG. 17C, the translation automation device 120 may compare the similarity calculated for each of the 10 term items and aggregate translation results having higher similarity, thereby producing a translation result set.

Further, the translation automation device 120 may verify the translation results by comparing the similarity calculated for each of the 10 term items in the translation result set with a similarity threshold (e.g., 90%) according to a category.

In this case, it is also possible to retranslate the items that do not meet the similarity threshold (e.g., in FIG. 17C, item 9 (project basic information) and item 10 (project transfer) have similarities of only 75% and 70%, respectively, failing to meet the similarity threshold (90%).

Furthermore, a computer program according to another aspect of the present disclosure is a computer program stored in a computer-readable medium in order to execute, on a computer, a series of steps of the above-described translation automation method. The computer program may be a computer program including machine language code produced by a compiler, and also be a computer program including high-level language code that can be executed on a computer by using an interpreter or the like. The computer is not limited to a personal computer (PC) or a notebook computer, but includes any information processing device, having a central processing unit (CPU) and capable of executing a computer program, such as a server, a smartphone, a tablet PC, a PDA, or a mobile phone.

Furthermore, the computer-readable medium may continuously store a computer-executable program, or temporarily store the computer-executable program for execution or download. Furthermore, the medium may be any of various recording or storage means formed by combining a single or multiple hardware units, and may not be limited to a medium directly connected to a computer system, but may be distributed over a network. Accordingly, the above detailed description should not be construed as limiting in any respect and should be considered to be exemplary. The scope of the present disclosure should be determined by a reasonable interpretation of the appended claims, and all changes within the equivalents of the present disclosure are included in the scope of the present disclosure.

Further, a translation automation device 120 according to an embodiment of the present disclosure is a device which includes: a processor; and a memory, and translates given original text. The memory may be configured to store instructions which, when executed by the processor, cause the device to implement specific operations. The specific operations may include: selecting, based on a given priority table, at least one unique expression set to be applied to the translation of the original text from a local rule that includes multiple types of unique expression sets; translating the original text by applying the at least one selected unique expression set to produce translated text; and updating the priority table, based on the produced translated text.

Here, the multiple types of unique expression sets included in the local rule may include at least two of a word set, a term set, a domain set, and a sentence set.

Furthermore, in the selecting of the at least one unique expression set, at least one artificial intelligence model corresponding to the at least one unique expression set to be applied to the translation of the original text may be selected.

In this case, the priority table may include a priority evaluation value of each of the multiple types of unique expression sets corresponding to multiple types of artificial intelligence models.

Furthermore, the producing of the translated text may include: selecting a region corresponding to the at least one unique expression set from the original text; evaluating the extent to which an expression in the selected region, corresponding to the at least one unique expression set, has been reflected in the translated text; and determining whether to retranslate the original text, based on the evaluation result.

Furthermore, retranslating the original text may be further included.

In this case, the retranslating of the original text may include: producing revised translated text by reflecting the expression corresponding to the at least one unique expression set in a non-reflected region in the translated text that does not reflect the expression corresponding to the unique expression set; and conducting retranslation of the original text in consideration of the revised translated text.

Furthermore, the conducting of the retranslation may include: determining whether the number of times the translated text is retranslated exceeds a predetermined number of times; and determining whether an evaluation value of the extent to which the expression corresponding to the at least one unique expression set has been reflected in the translated text meets a predetermined threshold.

Furthermore, in the updating of the priority table, the priority table may be updated based on the evaluation value of the extent to which the expression corresponding to the at least one unique expression set has been reflected in the translated text.

Furthermore, the producing of the translated text may include: translating the original text from a source language of the original text into a target language to produce first translated text; translating the first translated text from the target language into the source language to produce first retranslated text; and verifying the translation result, based on the original text and the first retranslated text.

Furthermore, the producing of the first translated text may include: translating the original text from a source language of the original text into a target language to directly produce the first translated text; and translating the original text from the source language into an intermediate translation language to produce first intermediate translated text, and translating the first intermediate translated text from the intermediate translation language into the target language to produce second translated text.

Furthermore, the producing of the first retranslated text may include: translating the first translated text from the target language into the source language to directly produce the first retranslated text; and translating the second translated text from the target language into the intermediate translation language to produce second intermediate translated text, and translating the second intermediate translated text from the intermediate translation language into the source language to produce second retranslated text.

Furthermore, in the performing of the verification, the verification may be performed based on at least two of the original text, the first retranslated text, and the second retranslated text to produce the translated text of the original text.

Furthermore, in the performing of the verification, the original text may be translated again when the verification of the translation result is not satisfied.

Furthermore, in the performing of the verification, the translation result may be verified by calculating first similarity between the original text and the first retranslated text and second similarity between the original text and the second retranslated text and comparing the first similarity and the second similarity with a predetermined similarity threshold.

Furthermore, in the performing of the verification, the similarity threshold may be applied differently depending on the category of the original text to be translated.

Furthermore, FIG. 18 illustrates a computing device 50 to which the method proposed by the present disclosure may be applied.

Referring to FIG. 18, the computing device 50 may be configured to implement a translation automation process according to the method proposed by the present disclosure.

For example, the computing device 50 to which the method proposed by the present disclosure may be applied may include a network device, such as a repeater, a hub, a bridge, a switch, a router or a gateway, a computer device, such as a desktop computer or a workstation, a mobile terminal, such as a smartphone, a portable device, such as a laptop computer, electric home appliances, such as a digital televisions, a moving means, such as a vehicle. As another example, the computing device 50 to which the present disclosure may be applied may be included as part of an application specific integrated circuit (ASIC) implemented in a system-on-chip (SoC) form.

A memory 20 may be operatively connected to a processor 10, may store programs and/or instructions for processing and control by the processor 10, and may store data and information used in the present disclosure, control information required for processing data and information according to the present disclosure, temporary data generated in the process of processing data and information, and the like. The memory 20 may be implemented as a storage device such as read-only memory (ROM), random access memory (RAM), erasable programmable read-only memory (EPROM), electrically erasable programmable read-only memory (EEPROM), flash memory, static RAM (SRAM), hard disk drive (HDD), or solid-state drive (SSD).

The processor 10 may be operatively connected to the memory 20 and/or a network interface 30, and controls the operation of each module in the computing device 50. In particular, the processor 10 may perform various control functions for carrying out the method proposed by the present disclosure. The processor 10 may also be referred to as a controller, a microcontroller, a microprocessor, a microcomputer, and the like. The method proposed by the present disclosure may be implemented by hardware, firmware, software, or a combination thereof. In the case of implementing the present disclosure by using hardware, the processor 10 may include an application-specific integrated circuit (ASIC), a digital signal processor (DSP), a digital signal processing device (DSPD), a programmable logic device (PLD), a field programmable gate array (FPGA), or the like configured to perform the present disclosure. Further, when firmware or software is used to implement the method proposed by the present disclosure, the firmware or the software may include instructions relating to modules, procedures, or functions for performing functions or operations required to implement the method proposed by the present disclosure. The instructions may be stored in the memory 20 or stored on a computer-readable recording medium (not shown) separate from the memory 20, and may be configured to, when executed by the processor 10, cause the device 50 to implement the method proposed by the present disclosure.

In addition, the computing device 50 may include the network interface device 30. The network interface device 30 is operatively connected to the processor 10, and the processor 10 may control the network interface device 30 to transmit or receive wireless/wired signals carrying information and/or data, signals, messages, etc. over a wireless/wired network. The network interface device 30 supports various communication standards, such as IEEE 802 series, 3GPP LTE(-A), and 3GPP 5G, and may transmit or receive control information and/or data signals according to these communication standards. The network interface device 30 may be implemented outside the computing device 50 as needed.

Accordingly, a method, a device, a system, and a computer program for local-rule-based translation automation may provide translation optimized for a specific field, based on a local rule, may automate translation while reducing significant time and cost that may be required when an expert or the like performs translation based on a local rule, may effectively reduce translation quality deterioration that may occur during translation reflecting a local rule, based on artificial intelligence models, may produce accurate translation results while requiring fewer resources, and may efficiently perform multilingual translation for multiple languages.

Various embodiments of the present disclosure do not list all available combinations but are for describing a representative aspect of the present disclosure, and descriptions of various embodiments may be applied independently or may be applied through a combination of two or more.

A number of embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A processor-implemented method, the method comprising:
selecting, based on a given priority table, at least one unique expression set to be applied to a translation of original text from a local rule, the local rule comprising multiple types of unique expression sets;
translating the original text by applying the at least one selected unique expression set to produce translated text; and
updating the priority table, based on the produced translated text.

2. The method of claim 1, wherein the multiple types of unique expression sets comprise at least two among a word set, a term set, a domain set, and a sentence set.

3. The method of claim 1, wherein the selecting comprises:
selecting at least one artificial intelligence model corresponding to the at least one unique expression set to be applied to the translation of the original text.

4. The method of claim 3, wherein the priority table comprises a priority evaluation value of each of the multiple types of unique expression sets corresponding to multiple types of artificial intelligence models including the selected at least one artificial intelligence model.

5. The method of claim 1, wherein the translating comprises:
selecting a region corresponding to the at least one unique expression set from the original text;
evaluating whether an expression in the selected region, corresponding to the at least one unique expression set, has been reflected in the translated text; and
determining whether to retranslate the original text, based on a result of the evaluation.

6. The method of claim 5, further comprising:
retranslating the original text responsive to the determination to retranslate the text.

7. The method of claim 6, wherein the retranslating comprises:
producing revised translated text by reflecting the expression corresponding to the at least one unique expression set in a non-reflected region in the translated text that does not reflect the expression corresponding to the unique expression set; and
retranslating the original text in consideration of the revised translated text.

8. The method of claim 7, wherein the retranslating comprises:
determining whether a number of times the translated text is retranslated exceeds a predetermined number of times; and
determining whether an evaluation value of whether the expression corresponding to the at least one unique expression set has been reflected in the translated text meets a predetermined threshold.

9. The method of claim 1, wherein in the updating, the priority table is updated based on an evaluation value of whether the expression corresponding to the at least one unique expression set has been reflected in the translated text.

10. The method of claim 1, wherein the translating comprises:
a forward translation for translating the original text from a source language of the original text into a target language to produce first translated text;
a backward translation for translating the first translated text from the target language into the source language to produce first retranslated text; and
verifying the produced translated text, based on the original text and the first retranslated text.

11. The method of claim 10, wherein the forward translation comprises:
a first forward translation for translating the original text from a source language of the original text into a target language to directly produce first translated text; and
a second forward translation for translating the original text from the source language into an intermediate translation language to produce first intermediate translated text, and translating the first intermediate translated text from the intermediate translation language into the target language to produce second translated text, and
wherein the backward translation comprises:
a first backward translation for translating the first translated text from the target language into the source language to directly produce the first retranslated text; and
a second backward translation for translating the second translated text from the target language into the intermediate translation language to produce second intermediate translated text, and translating the second intermediate translated text from the intermediate translation language into the source language to produce second retranslated text.

12. The method of claim 11, wherein the verifying is performed based on at least two of the original text, the first retranslated text, and the second retranslated text to produce translated text of the original text.

13. The method of claim 10, wherein the verifying comprises:
translating the original text again responsive to the verifying not being satisfied.

14. The method of claim 10, wherein verifying comprises:
calculating a first similarity between the original text and the first retranslated text and a second similarity between the original text and the second retranslated text and comparing the first similarity and the second similarity with a predetermined similarity threshold.

15. The method of claim 14, wherein in the verifying, the similarity threshold is applied differently depending on a category of the original text to be translated.

16. A device, the device comprising:
one or more processors configured to execute instructions; and
a memory storing the instructions, wherein execution of the instructions configures the one or more processors to: select, based on a given priority table, at least one unique expression set to be applied to a translation of an original text from a local rule, the local rules comprising multiple types of unique expression sets;
translate the original text by applying the at least one selected unique expression set to produce translated text; and
update the priority table, based on the produced translated text.

17. The device of claim 16, wherein the selecting comprises:
selecting at least one artificial intelligence model corresponding to the at least one unique expression set to be applied to the translation of the original text.

18. The device of claim 17, wherein the priority table comprises a priority evaluation value of each of the multiple types of unique expression sets corresponding to multiple types of artificial intelligence models including the selected at least one artificial intelligence model.

19. The device of claim 16, wherein the translating comprises:
translating the original text from a source language of the original text into a target language to produce first translated text;
translating the first translated text from the target language into the source language to produce first retranslated text; and
verifying the translated text, based on the original text and the first retranslated text.

20. A computer-readable storage medium storing instructions that are configured to, when executed by a processor, cause a device, which comprises a processor and translates given original text, to implement specific operations, wherein the specific operations comprise:
selecting, based on a given priority table, at least one unique expression set to be applied to the translation of the original text from a local rule, the local rule comprising multiple types of unique expression sets;
translating the original text by applying the at least one selected unique expression set to produce translated text; and
updating the priority table, based on the produced translated text.
